(19) United States
(12) Patent Application Publication
(10) Pub. No.: US 2006/0070991 A1
(43) Pub. Date: Apr. 6, 2006

(54) Heating system and method for heating a light unit

(76) Inventors: Jim S. Powell, San Marcos, CA (US); Eric C.H. Chen, Hsin Chu Hsien (TW)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/302,848

(22) Filed: Dec. 14, 2005

(30) Foreign Application Priority Data
Jan. 6, 2005 (TW) 094100398

(51) Int. Cl. H05B 6/64

(52) U.S. Cl. 219/685

(57) ABSTRACT

A heating system and a heating method for heating a light unit are provided. The heating system mainly includes a heater for heating the light unit and a heat sensor electrically connected to the heater for detecting a thermal parameter of the light unit. In the provided heating system, the heater is cut off by the heat sensor when the thermal parameter is higher than a preset value.

### FIELD OF THE INVENTION

The present invention is directed to a heating system and method. More particularly, the present invention is directed to the heating system and method for heating a light unit

### BACKGROUND OF THE INVENTION

At present, a light unit is essential for the daily life and almost applied everywhere. However, in some cases, such as in the place without electricity power line supply and in the non-rail movable equipment such as vehicles or vessels, the situation of low temperature constantly happens and the efficiency of the light unit is thus reduced.

The principle adopted in the light unit such as a fluorescent light is that while the electron impacts to the vaporized metal, e.g. the mercury, an invisible light, such as the ultraviolet ray, may emit therefrom and then hit the fluorescent lamp so as to result in a visible light emission. If the temperature is lowered, however, the vaporized metal may condense as a liquid or even a solid, and it is hence difficult for the electron to impact to the metal for emitting invisible lights. Simply speaking, in low temperature, the fluorescent light is hard to be activated.

Therefore, to solve the problems about the low temperature, a heating filament combining with the fluorescent lamp is widely applied for heating the metal therein to be vaporized, so as to allow the electron to impact to the vaporized metal for emitting invisible lights sufficiently.

However, the mentioned technique in the prior art is so rough and only uses a switch for controlling the heater. So the user must manually switch on or off the heater. For example, when the heater is manually switched on to heat and vaporize the metal in the fluorescent lamp, the user must keep the heater being powered until the fluorescent lamp is lighted up. It is inconvenient because the user must keep his eye on the fluorescent lamp and the heater. The user can not cut off the heater until the visible light emits from the fluorescent light. Therefore, during the period for heating the lamp, the user cannot deal with anything else.

Furthermore, the mentioned technique in the prior art is further disadvantageous in that it is unable to automatically control the heater. This drawback is more serious because the manual operation always fails to correspondingly react to the variation of the heating speed rate. If the heating rate is too fast, it is difficult for the user to react thereto for stopping the heater in time. On the other hand, if the heating rate is too slow, the user may neglect the heater which is still active for heating the lamp, so that the lamp may be overheated, and the lamp or the heater may be broken accordingly. Besides, high temperature may result in a fire.

For overcoming the foregoing disadvantages of the conventional heater, a heating system and method for heating a light unit that can automatically cut off a heater thereof is provided in the present invention.

### SUMMARY OF THE INVENTION

In accordance with a first aspect of the present invention, a heating system for heating a light unit is provided. The heating includes a heater for heating the light unit and a heat sensor electrically connected to the heater for detecting a thermal parameter of the light unit, wherein the heater is cut off by the heat sensor when the thermal parameter is higher than a preset value.

Preferably, the preset value is set in the heat sensor.

Preferably, the heating system further includes a power source for the light unit and the heater.

Preferably, the power source includes a rectifier to rectify an electrical power outputted from the power source.

Preferably, the heat sensor is a thermistor.

Preferably, the light unit is a fluorescent lamp.

Preferably, the heater is a resistance heater.

Preferably, the heater is a heat radiator for emitting a heat radiation to the light unit.

In accordance with a second aspect of the present invention, a method for heating a light unit is provided. The method includes the following steps: (a) heating a light unit; (b) identifying whether one of following conditions is achieved: (b-1) a thermal parameter of the light unit is higher than a preset value, and (b-2) a time period for heating is longer than a preset period; and (c) stopping heating the light unit when one of step (b-1) and step (b-2) is achieved.

Preferably, the light unit is heated by a heater.

Preferably, the heater is electrically powered.

Preferably, the heater is one of a resistance heater and a heat radiator.

Preferably, the light unit is a fluorescent lamp.

Preferably, a light-emitting material in the light unit is heated by the heater.

Preferably, the method further includes a step of (c-1) activating the light unit.

Preferably, the method further includes a step of (d) when the light unit has a thermal parameter lower than a preset low-level temperature, performing the step (a).

In accordance with a third aspect of the present invention, a heating system for heating a light unit is provided. The heating system includes a heater for heating the light unit and a timer electrically connected to the heater, wherein when the heater is activated for a time period longer than a preset period, the heater is cut off by the timer.

Preferably, the preset period is set in the timer.

In accordance with a fourth aspect of the present invention, a heating system for a light unit is provided. The heating system includes a heater positioned adjacent to the light unit, a heat sensor electrically connected to the heater for detecting a thermal parameter of the light unit and having a preset value preset therein, and a timer electrically connected to the heater and having a preset period preset therein.

Preferably, while the thermal parameter is higher than the preset value, the heater is cut off by the heat sensor.

Preferably, while a heating period is longer than the preset period, the heater is cut off by the timer.

### BRIEF DESCRIPTION OF THE DRAWINGS

FIG. 1 is a block diagram showing the steps of the heating method according to the present invention;

FIG. 2 is a diagram schematically showing a heating system according to a first embodiment of the present invention;

FIG. 3 is a diagram schematically showing a heating system according to a second embodiment of the present invention;

FIG. 4 is a diagram showing the steps of the heating method according to another embodiment of the present invention; and

FIG. 5 shows the steps of the heating method according to yet another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of the invention are presented herein for purpose of illustration and description only; it is not intended to be exhaustive or to be limited to the precise form disclosed.

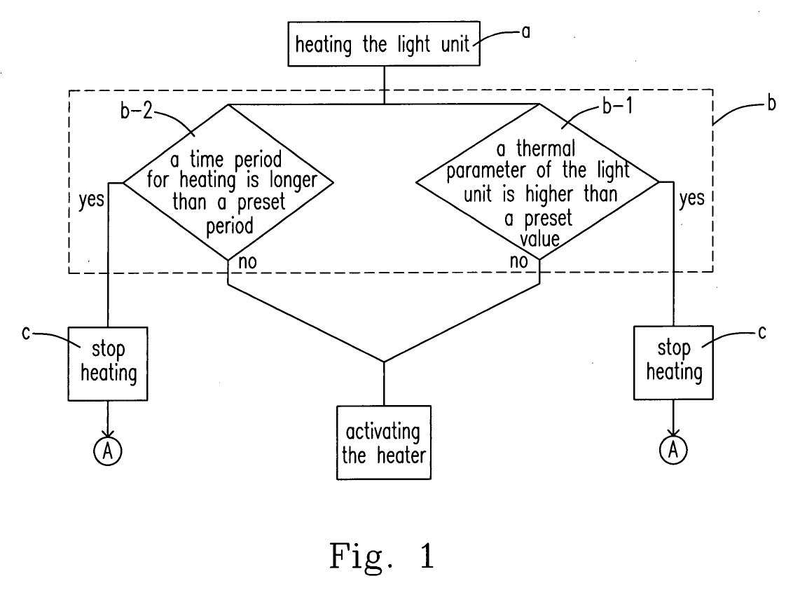

The heating method for heating a light unit according to the present invention will now be illustrated in detail by the following descriptions. Referring now to FIG. 1, an embodiment of the present invention is illustrated. The embodiment of the present invention shows a method for heating a light unit. The method includes the following steps. The first step is (a) heating a light unit, and during the heating period, it is necessary to identify whether one of the following conditions is achieved as shown in step (b), wherein one of the conditions is (b-1) a thermal parameter of the light unit is higher than a preset value, and the other condition is (b-2) a time period for heating is longer than a preset period. If any one of the above conditions is achieved, the third step of (c) stopping heating the light unit is performed.

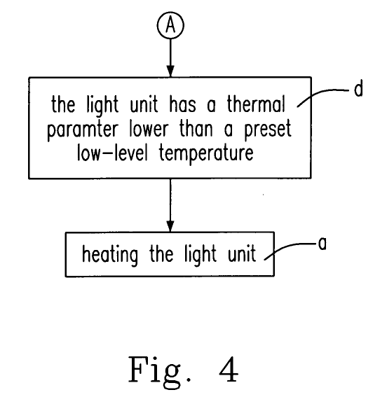

Typically, the condition (b-1) is achieved while the light unit is heated to a vaporizing point, i.e. the temperature at which the metal is vaporized for being impacted by electrons. Please refer to FIG. 4, which is a block diagram showing the steps of the heating method according to another embodiment of the present invention. In addition to the above steps, the heating method may further includes a step of (d) when the light unit has a thermal parameter lower than a preset low-level temperature, performing the step (a) for heating the light unit, so as to keep the light unit being in the most efficient status.

It is a direct scheme to arise the temperature for vaporizing the metal, however, if the light unit is heated for a period of time, the temperature thereof would also be high enough to achieve the vaporizing point of the metal. Therefore, it also needs to take the condition (b-2) into consideration in the present invention. When the condition (b-2) is achieved, the heating system also stops heating the light unit so that the light unit is well protected through the present invention.

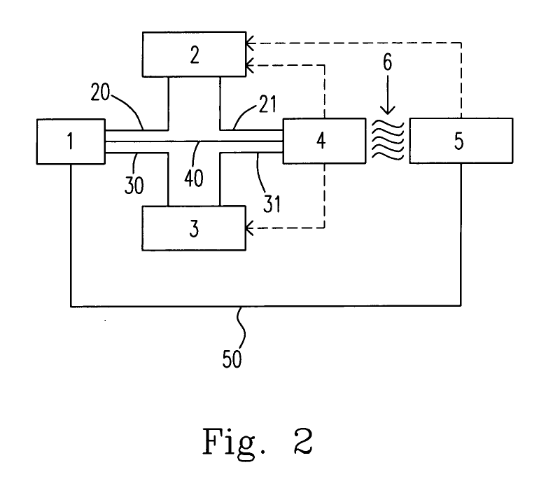

Please refer to FIG. 2, which is a diagram schematically showing the heating system according to a first embodiment of the present invention. The heating system includes a heat sensor 2, a timer 3, a heater 4, a light unit 5, and a power source 1 for supplying electric power to each component thereof. The power source 1 supplies electric power to the heat sensor 2 through a heat sensor wire 20, to the timer 3 through a timer wire 30, to the heater 4 through the heater wire 40, and to the light unit 5 by the light unit wire 50. The heat sensor 2 is configured to detect the respective thermal parameters of the heater 4 and the light unit 5. When one of the heater 4 and the light unit 5 is heated to a temperature higher than a preset temperature, the heat sensor 2 would cut off the heater 4 for stopping heating through the first controlling wire 21, so as to prevent the heater 4 and the light unit 5 from being burn out. The timer 3 is used for calculating a heating time period of the heater 4. When the heating time period is longer than a preset period, the timer 3 would also cut off the heater 4 through a second controlling wire 31, so as to prevent the heater 4 and the light unit 5 from being burn out. Therefore, while one of the two conditions is achieved, the heater 4 will stop heating the light unit 5 immediately.

As shown in FIG. 2, the heater 4 is positioned adjacent to the light unit 5. There are three different ways involved in the heat transfer 6 between the light unit 5 and the heater 4, i.e. conduction, convection, and radiation. If the heat is transferred via conduction, the heater 4 would be a heating filament. If the heat is transferred via radiation, the heater 4 would be an infra-red radiator. Moreover, in the case of convection, the heater 4 would be an air conditioner that the hot air is guided toward the light unit 5 via a duct (not shown) thereof. Therefore, various heating equipments are capable of being applied in the heating system. Furthermore, for applying a stable electric power, a rectifier (not shown) is further configured for the power source 1.

Typically, the light unit 5 would be a cold cathode fluorescent lamp (CCFL), which is popularly used in the vehicle. Additionally, other kinds of light units are also preferred, such as an LED. Moreover, if the battery of a vehicle is used as the power source 1, it is necessary to adapt an inverter (not shown) to convert the direct current into an alternating current for the CCFL.

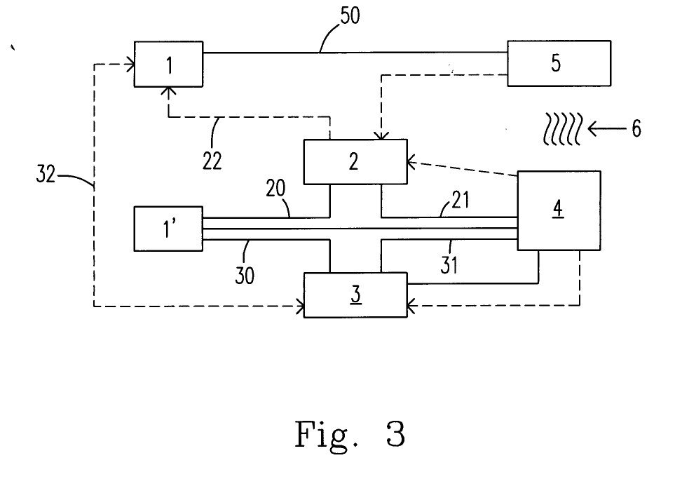

Please refer to FIG. 3, which is a diagram schematically showing the heating system according to a second embodiment of the present invention. Typically, the heating system of the present invention includes the heat sensor 2, the timer 3 and the heater 4. Of course the heater 4 is used for heating the light unit 5.

As shown in FIG. 3, the heater 4 is supplied with an electric power by an external power source 1′. The power source 1′ supplies the electric power to the heat sensor 2 through a heat sensor wire 20, to the timer 3 through a timer wire 30, to the heater 4 through the heater wire 40, and to the light unit 5 through the light unit wire 50. In other words, the electric power for the heat sensor 2, the timer 3, and the heater 4 is separate from that for the light unit 5. Therefore, the heating system including the heat sensor 2, the timer 3, and the heater 4 is applied not only for heating the light unit 5 in the present invention, but also for sufficiently heating the conventional light unit.

Based on the above description, the present invention is advantageous for having an automatical controllability, which is achieved by the cooperation of the heater 4 and the heat sensor 2 as well as the heater 4 and the timer 3.

As shown in FIG. 3, the light unit 5 is supplied with an electric power by the power source 1 through the light unit wire 50. The heat sensor 2 is used for detecting the respective thermal parameters of the heater 4 and the light unit 5. When one of the heater 4 and the light unit 5 is heated to a temperature higher than a preset temperature, the heat sensor 2 would cut off the heater 4 for stopping heating through the first controlling wire 21, so as to prevent the heater 4 and the light unit 5 from being burn out. The timer 3 is used for calculating a heating time period of the heater 4. When the heating time period is longer than a preset period, the timer 3 would also cut off the heater 4 through a second controlling wire 31, so as to prevent the heater 4 and the light unit 5 from being burn out. Therefore, while one of the two conditions is achieved, the heater 4 will stop heating the light unit 5 immediately.

There are three different ways involved in the heat transfer 6, i.e. conduction, convection, and radiation. If the heat is transferred via conduction, the heater 4 would be a heating filament. If the heat is transferred via radiation, the heater 4 would be an infra-red radiator. Moreover, in the case of convection, the heater 4 would be an air conditioner that the hot air is guided toward the light unit 5 via a duct (not shown) thereof.

While a radiator, such as an infra-red radiator, is used as the heater 4, it is configured in such a way that the radiation emitting direction is toward the light unit 5, and the heat sensor 2 is positioned at a place where the thermal parameters of the heater 4 and the light unit 5 are detectable. The operation of the timer 3 shown in FIG. 3 is similar to that in FIG. 2, which is not repeated.

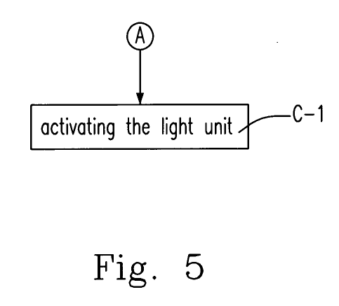

Please refer to FIG. 5, which shows the steps of the heating method according to yet another embodiment of the present invention. In comparison with the method shown in FIG. 1, the method in FIG. 5 further has a step of (c-1) activating the light unit after the step (c). The reason for performing the step (c-1) is that it is not necessary to activate the light unit until the temperature thereof is high enough. Please also refer to FIG. 2, when the thermal parameter of the light unit 5, such as the temperature, is high enough, the heat sensor 2 would send a signal to the power source 1 through the heat sensor wire 20 (correspondent to heat sensor signal wire 22 in FIG. 3), so that the power source 1 would supply electric power to the light unit 5 through light unit wire 50. Such a function is achieved by the timer 3. When the preset heating time period is achieved, the timer 3 would send a signal to the power source 1 through the timer wire 30 (correspondent to timer signal wire 32 in FIG. 3), so that the power source 1 would supply an electric power to the light unit 5 through light unit wire 50. As a result, the light unit 5 is supplied with an electric power only when the temperature thereof is high enough to vaporize the metal, hence the waste of the electric power is prevented.

While the invention has been disclosed in terms of what is presently considered to be the most practical and preferred embodiments, it is to be understood that the invention needs not to be limited to the disclosed embodiments. On the contrary, it is intended to cover various modifications and similar arrangements included within the spirit and scope of the appended claims which are to be accorded with the broadest interpretation so as to be accorded with the broadest interpretation so as to encompass all such modifications and similar structures.

1. A heating system for heating a light unit, comprising:
a heater for heating said light unit;
a heat sensor electrically connected to said heater for detecting a thermal parameter of said light unit, wherein said heater is cut off by said heat sensor when said thermal parameter is higher than a preset value.

2. The heating system according to claim 1, wherein said preset value is set in said heat sensor.

3. The heating system according to claim 1, further comprising a power source for said light unit and said heater.

4. The heating system according to claim 3, wherein said power source comprises a rectifier to rectify an electrical power outputted from said power source.

5. The heating system according to claim 1, wherein said heat sensor is a thermistor.

6. The heating system according to claim 1, wherein said light unit is a fluorescent lamp.

7. The heating system according to claim 1, wherein said heater is a resistance heater.

8. The heating system according to the claim 1, wherein said heater is a heat radiator for emitting a heat radiation to said light unit.

9. A method for heating a light unit, comprising:
(a) heating a light unit;
(b) identifying whether one of following conditions is achieved;
(b-1) a thermal parameter of said light unit is higher than a preset value; and
(b-2) a time period for heating is longer than a preset period;
(c) stopping heating said light unit when one of step (b-1) and step (b-2) is achieved.

10. The method according to claim 9, wherein said light unit is heated by a heater.

11. The method according to claim 9, wherein said heater is electrically powered.

12. The method according to claim 11, wherein said heater is one of a resistance heater and a heat radiator.

13. The method according to claim 9, wherein said light unit is a fluorescent lamp.

14. The method according to claim 9, wherein a light-emitting material in said light unit is heated by said heater.

15. The method according to claim 9, wherein said step (c) further comprises a step of: (c-1) activating said light unit.

16. The method according to claim 9, further comprising a step of: (d) when said light unit has a thermal parameter lower than a preset low-level temperature, performing said step (a).

17. A heating system for heating a light unit, comprising:
a heater for heating said light unit;
a timer electrically connected to said heater, wherein when said heater is activated for a time period longer than a preset period, said heater is cut off by said timer.

18. The system according to claim 17, wherein said preset period is set in said timer.

19. A heating system for a light unit, comprising:
a heater positioned adjacent to said light unit;
a heat sensor electrically connected to said heater for detecting a thermal parameter of said light unit, and having a preset value preset therein, wherein while said thermal parameter is higher than said preset value, said heater is cut off by said heat sensor; and
a timer electrically connected to said heater and having a preset period preset therein, wherein while a heating period is longer than said preset period, said heater is cut off by said timer.
